(19) United States
(12) Patent Application Publication
(10) Pub. No.: US 2014/0129730 A1
(43) Pub. Date: May 8, 2014

(54) METHODS AND APPARATUS FOR REAL TIME DELIVERY OF HETEROGENEOUS CONTENT

(71) Applicant: Collaborative Knowledge Inc. d/b/a Zerellium, San Jose, CA (US)

(72) Inventors: Mark Phillips, San Jose, CA (US); Ivan Memruk, San Mateo, CA (US)

(73) Assignee: Collaborative Knowledge Inc. d/b/a Zerellium, San Jose, CA (US)

(21) Appl. No.: 14/069,736

(22) Filed: Nov. 1, 2013

Related U.S. Application Data
(60) Provisional application No. 61/721,854, filed on Nov. 2, 2012.

(51) Int. Cl. H04L 29/06

(52) U.S. Cl. CPC H04L 65/607
USPC 709/231

(57) ABSTRACT

Techniques for delivering electronic content over a network are provided, and in particular, techniques for real time delivery of heterogeneous content. The system may be a combination of cloud-based backend software, platform-specific client-side software and a set of network protocols that together deliver custom combinations of live and previously-created content streams of different types to various consumer devices over the a network such as the Internet.

### CROSS-REFERENCE TO RELATED APPLICATIONS

The present application claims the benefit under 35 U.S.C. §119(e) of U.S. Provisional Application Ser. No. 61/721,854 filed on Nov. 2, 2012, titled, “METHODS AND APPARATUS FOR REAL TIME DELIVERY OF HETEROGENEOUS CONTENT,” which is hereby incorporated by reference in its entirety.

### FIELD OF THE INVENTION

The techniques described herein are directed generally to the field of delivering electronic content, and more particularly to techniques for real time delivery of heterogeneous content.

### DESCRIPTION OF THE RELATED ART

Today, the Internet has become the main platform to deliver various kinds of information to billions of users worldwide. Based on the core protocols such as Transmission Control Protocol (TCP) and User Datagram Protocol (UDP), application developers have created software systems that are capable of delivering many kinds of content to the consumer, including text, video, audio, documents and images.

### SUMMARY

The inventors have recognized and appreciated the desirability of improved techniques for delivering heterogeneous content to various devices including mobile devices.

One type of embodiment is directed to a method of making heterogeneous content available to a client device over a network. The method includes acts of accepting a live content stream and pre-recorded content, combining the live content stream and the pre-recorded content into a unified stream, and making the combined content stream available over a network to a client.

Another type of embodiment is directed to an apparatus for making heterogeneous content available to a client device over a network. The apparatus includes a multiplexing (or “Mux”) module configured to combine a plurality of content streams into a unified content stream, and a transcoder module configured to encode the content within the content stream based on client device requirements and/or network conditions. The apparatus further includes a content endpoint module configured to communicate with a client device over a network.

### BRIEF DESCRIPTION OF DRAWINGS

The accompanying drawings are not intended to be drawn to scale. For purposes of clarity, not every component may be labeled in every drawing. In the drawings:

FIG. 1 is a diagram of the high level architecture of a system incorporating one embodiment of the present disclosure;

FIG. 2 shows modular system components and their categorization according to one embodiment of the disclosure;

FIG. 3 is a diagram of the system architecture according to one embodiment of the present disclosure; and

FIG. 4 is an illustrative implementation of a computer system that may be used in connection with some embodiment of the present disclosure.

### DETAILED DESCRIPTION

While from the pure software point of view, most kinds of information that are processed by software and transmitted over the Internet are, at some level, linear sequences of bytes, it is, in fact, human perception of different types of information that requires software components and network protocols to differ so widely for different information exchange scenarios. For example, transmitting a page of text from one computer to another over the internet is a different type of problem as compared to transmitting a real time video stream of somebody reading that page out loud for an audience. Another example is encoding a piece of music into a MIDI file (a set of musical notes with assigned timing that can be played back by a capable device), versus encoding a piece of music into an MP3 file (a stream of audio amplitude values, transformed into the frequency domain and quantized for compression using a complex algorithm).

Also of significance is the context in which the data is transferred. For example, IPTV streaming and video call applications essentially deal with the same types of data—audio and video. However, in the IPTV streaming context, latency (delay) of data transmission is much less important—although it is desirable to keep it within 10-30 seconds, it is definitely less a priority than other factors, for example quality of the video and absence of interruptions. When performing a video call, however, latency is arguably the most important factor to make the perceptual call quality as good as possible, which is often done at the cost of decreasing the quality of each individual video/audio frame.

It is no surprise then, that the whole software stacks which are designed to transfer different kinds of data in different contexts, although being quite advanced, have diverged into a variety of directions. In addition, only some of the information/context combinations have even a basic level of an implementation standard. For example, video calling via Skype® and video calling via a Cisco® VoIP solution involve completely different protocols, different codecs and different network topologies. Internet radio is an example of better standardization, as almost all non-duplex audio streaming is based on one of a small number of formats and codecs, such as MP3 or ASF as the codec, an M3U file as the discovery mechanism and HTTP as the transport protocol, etc. However, the diversity of content streaming mechanisms and stacks is phenomenal and keeps growing every day, while almost all standardization initiatives lag so far behind that the very subjects that the standards aim to standardize become obsolete before standards are adopted.

This situation is advantageous to those who build their businesses on creating better proprietary content delivery technology stacks, but it creates a set of challenges to those who actually own the content and wish to have a solution to transmit it to consumers. For example, even publishing video content on a website requires a complex and often costly decision about which solution to use. Should the content be hosted locally or on a 3rd party video hosting? Should a Flash-based player be used to deliver the video to web browsers, or should HTML5 be used instead? Will the chosen solution be able to deliver the video to mobile devices? Can the solution deliver live video streaming or only pre-recorded video? The video quality and bandwidth boundaries that a solution can support also should be considered

An even harder challenge is providing different types of content together. One example is the provision of live stock quotes supported by multiple TV news streams between which the user can switch the focus as she likes. Another example is the showing of a video to a distance education class with the teacher's narrative layered over the original soundtrack of the video stream, along with presentation slides on the side of the screen. Today this class of problems almost certainly requires costly custom application development.

Another dimension which makes the challenge of content delivery even more complex is the variety of client devices that the consumer wants to use to receive the content. Laptops, tablets, and mobile phones all use different hardware and run different operating systems. Additionally each client device has different physical properties that affect what the consumer can and cannot do with the device. In the context of delivering content, the publisher needs to be aware of these extra problems, and adjust the content delivery format so that it is 1) possible to deliver the content to the consumer's preferred device; and 2) convenient for the consumer to use the content on their preferred device.

To summarize, challenges include:
Different kinds of information in different contexts are encoded and transmitted via widely different technology stacks
Delivering heterogeneous types of content together requires custom software development at low level
Accommodating the variety of client devices that are in use by consumers, including portable devices, tablets, laptops and others.

Accordingly, some embodiments described herein relate to techniques for delivering heterogeneous content in the context of these challenges.

The aspects of the present invention described herein can be implemented in any of numerous ways, and are not limited to any particular implementation techniques. Thus, while examples of specific implementation techniques are described below, it should be appreciate that the examples are provided merely for purposes of illustration, and that other implementations are possible.

Overview

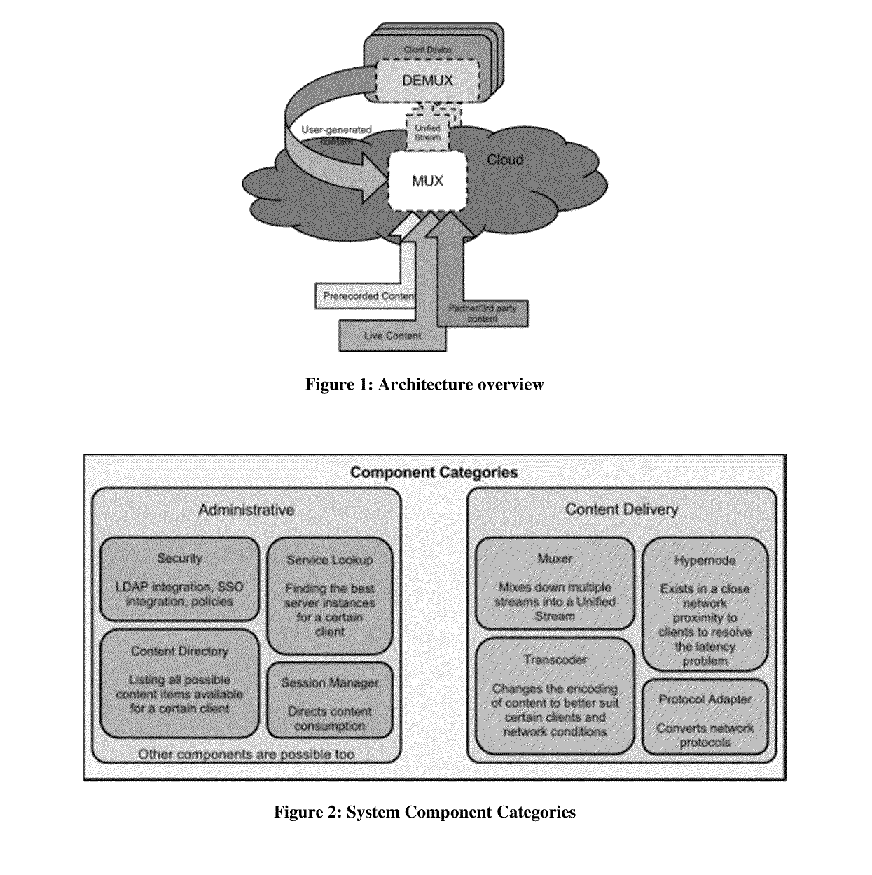

The described system is a combination of cloud-based backend software, platform-specific client-side software and a set of network protocols that together implement a solution to the problem of delivering custom combinations of live and previously created content streams of different types to various consumer devices over the Internet. As shown in FIG. 1, the system may include the following properties:

1. Highly configurable and designed to accept numerous input stream sources, both live and prerecorded on the backend side.

2. Via configuration, the system can combine streams of live, prerecorded, user-generated and third party content into a custom real time Unified Stream that can be consumed by the client apps on various platforms, thus allowing a variety of content-based applications without the need for custom coding.

3. The backend portion is hosted in the cloud and does not impose cost or effort on the publisher.

4. The challenges associated with delivering heterogeneous content is thus taken from the custom development domain into the configuration/administration domain, as the system addresses the complicated problems related to delivering various types of content within quality, performance and other boundaries.

Content Classification Content types that the system accommodates can be classified by the following criteria:

1. By perceptual type:
a. Purely visual—documents, images, photos, presentation slides;
b. Purely audial—radio broadcasts, music recordings, audiobooks, voice calls;
c. Audiovisual—live video broadcasts, prerecorded videos, videoconference calls.

2. By generation time:
a. Live—voice or video calls, live broadcasts, IM exchanges, stock quotes, live presentations, Twitter updates.
b. Previously created—audio or video recordings, documents, prerecorded presentations.

3. By interactivity:
a. One-way—broadcasts, stock quotes, presentations, music recordings;
b. Interactive—video and voice calls, IM, multi-user whiteboards, press-conferences.

Some of the class divisions are blurred, for example a lot of formally interactive types of content only provide simple interactivity functions, such as the ability to type a question in text to a teacher during a live audio/video educational presentation. Such an interactive content item is still one-way for most of the time, unlike, for example, a voice call with presentation slides simultaneously shown on the screen by one of the presenters that is used to discuss a technical proposal. Additionally, interactivity often implies live content.

The classification above is important for understanding the full scope of capabilities of the system. The ability for the publisher to easily combine different classes of content is nontraditional, it removes a serious barrier related to custom development, and opens the door both to solving well-known and painful problems, and to bringing new value to the consumers that has not been thought of before.

Another reason to understand the classification of content is the way the system deals with content based on its class. For example, during inevitable network slowdowns and packet losses, live and interactive content will generally be adjusted to reduce latency, while previously created, one-way content will be adjusted to preserve its quality. In general, the system is configurable with a set of rules assigned to each input stream, to define its behavior when certain pieces of content fail to be delivered on time.

Application Building Process

As shown above, the system takes the complexity of custom development out of the content delivery problem. Thus, the process of building a specific application using the system may include the following steps:

1. Problem identification—assessment of the content delivery solution that is needed. Includes the following steps:
a. Identification of purpose—what the application is going to be used for;
b. Identification of content types—what types of content the application will deliver;
c. Identification of boundaries—what conditions the application needs to support. For example, will the application run on 3G networks or only on Wi-Fi.

2. System engagement—setting up the system to implement a certain application.
a. Creation of a separate application entity within the system, typically via the web-based configuration interface, or via an automated API;
b. Configuration of the streams—defining and configuring each stream that the application contains, again via UI or API;
c. Configuration of other settings—QoS, security, user groups etc.—via UI or API.

3. Client engagement—engaging the consumers to set up their devices for the application
a. If the application is purely focused on content delivery, then in most cases installing the standard app that is distributed via the platform-specific methods (such as iTunes for iOS devices) is enough—the desired application will appear in the user's list as they launch the platform client application;
b. If the application uses the system for content delivery but adds some extra non-content related functionality on top, then the system's functionality can be integrated into a custom platform application via a high-level SDK, and the resulting application is distributed by the Publisher.

The outcome of this process is a fully working custom content delivery application.

System Design

The system is arranged as a set of modular blocks (components) each serving a single and clear purpose. This allows content publishers to deploy the system in different manners, such as on private hosted servers, private cloud or public cloud infrastructure. In addition, as discussed below, modularity allows effective network deployment to limit negative effects of TCP/IP networks such as latency.

Components largely serve one of two purpose categories: administrative and content delivery. Administrative components, such as security, content directory or geo-lookup, facilitate business logic and are customizable to support different use cases. Content delivery components are arranged to deliver the content with high quality or with high real time guarantees, depending on content type.

Extensibility of the system is achieved by opening up the APIs of the administrative components to allow advanced integration scenarios.

Administrative components represent the open, “enterprise” portion of the system, and are easy to understand and use terminology and structure familiar to system architects in any enterprise company.

FIG. 2 shows one embodiment of categorization of components in more detail.

Technical Stack

The system may take advantage of some of the protocols that are quasi-standard in the real time content delivery space. As discussed above, the industry is far from being standardized, yet some of the protocols that are commonly used are well-developed and widely known, albeit not universal.

Table 1 shows protocols that may be used within the system in some embodiments, and for what purpose.

TABLE 1
Summary of Network Protocols Used in Some Embodiments of the System

| Purpose | Network Protocol | Comments |
|---|---|---|
| Real time/lossy content delivery | RTP¹ with SRTP² | Content is securely encoded in the system. |
| (where latency is more | extensions, and RTCP | RTP is an application-layer protocol, the system uses |
| important) | for QoS. | it over different transport-layer protocols (TCP and |
| | | UDP) where necessary. |
| Lossless content delivery | HTTP³ (with TLS) | Losslessness/lossiness also depends on the codec |
| | | used, but RTP does not guarantee losslessness even if |
| | | used over TCP. |
| Administrative operations | XMPP⁴ | In some embodiments, “real time” administrative |
| (presence & session related) | | operations use XMPP while the rest use HTTP for |
| | | simplicity. |
| Administrative operations | HTTP/REST (with | |
| (general) | TLS) | |

¹See Appendix A (RFC: http://tools.ietf.org/html/rfc3550)
²Proposed standard; See Appendix B (RFC: http://tools.ietf.org/html/rfc3711)
³See Appendix C (RFC: http://www.w3.org/Protocols/rfc2616/rfc2616.html)
⁴See Appendix D (RFC: http://xmpp.org/rfcs/rfc3921.html)

The system uses only open standard protocols in some embodiments, though in other embodiments other protocols may be used.

Regarding content codecs, the system is agnostic and allows full flexibility in some embodiments. For example, in some embodiments, the system includes only open codecs such as Opus for audio and Theora for video. If the publisher possesses the respective licenses, the System is configurable to use proprietary codecs such as MPEG-4, AAC, etc.

Regarding implementation technology, some, most or all of the code may be based on cross-platform technologies that is easily ported to major platforms. In some embodiments, the platform for the backend is 64-bit Linux/x86.

On the client side, the system may be easily ported to most x86 and ARM devices. All client code may be implemented using open-source technologies in some embodiments.

Table 2 shows a list of basic libraries and frameworks used both on the backend and on the client side in some embodiments, with license information and purpose description. More libraries can potentially be engaged if extra content types are used in a custom deployment of the system. For example, if PDF content is used, a commercial library may be added to the system.

A significant number of other libraries, such as those coming from the Apache Commons project, have a BSD, MIT or Apache License.

Some of the libraries have additional dependencies, and in some embodiments, these dependencies are limited to dependencies which use open-source, permissive licenses.

TABLE 2
List of Basic Libraries and Frameworks used in the System

| Library | License | Purpose | Comment |
|---|---|---|---|
| Opus Audio | BSD | Encoding both low-latency | Standardized as an RFC |
| Codec | | and high-quality audio. | |
| Theora | BSD | Encoding video | |
| Smack/ASmack | Apache | XMPP protocol | |
| | | implementation for Java and | |
| | | Android ™ | |
| XMPPFramework | BSD | XMPP protocol | |
| | | implementation for iOS ™/ | |
| | | MacOS X ™ | |
| Mongo DB | BSD | Large-scale data storage in | Driver components are BSD-licensed while the |
| Drivers | | Mongo DB | database engine itself, which requires no |
| | | | modification or linking, is AGPL. |
| SQLite | Public | Small-scale (local) data | |
| | domain | storage | |
| Node.js | BSD | Scalable HTTP server | |
| | | infrastructure | |
| jQuery | MIT | Rich administrative UI and | |
| | | web client | |
| Boost Framework | BSD- | Various C++ utilities | |
| | style | | |

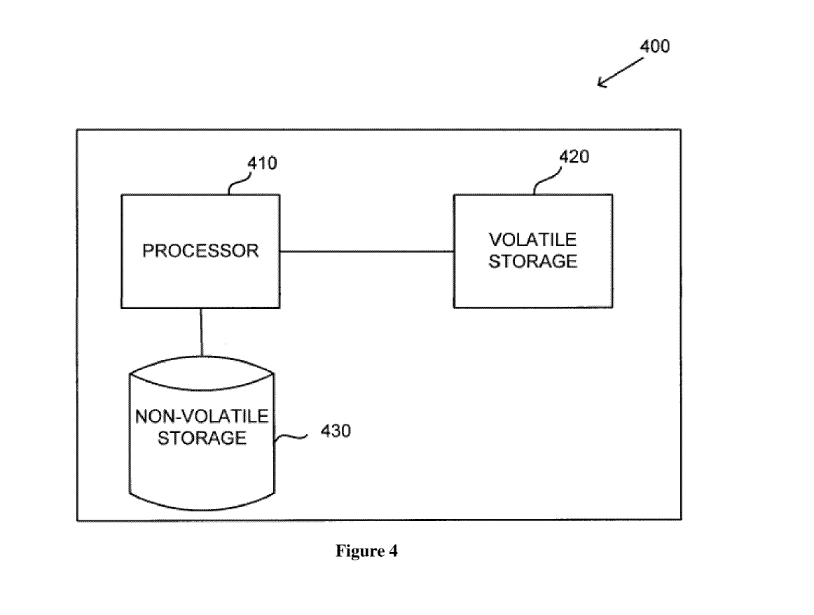

It is important to note that the list of libraries and frameworks shown in FIG. 4 is not necessarily a complete list of components for every system. Commercial deployments may include proprietary components which are not required, but to which the system is open. Additionally, not every component listed must be used in every embodiment.

Architecture

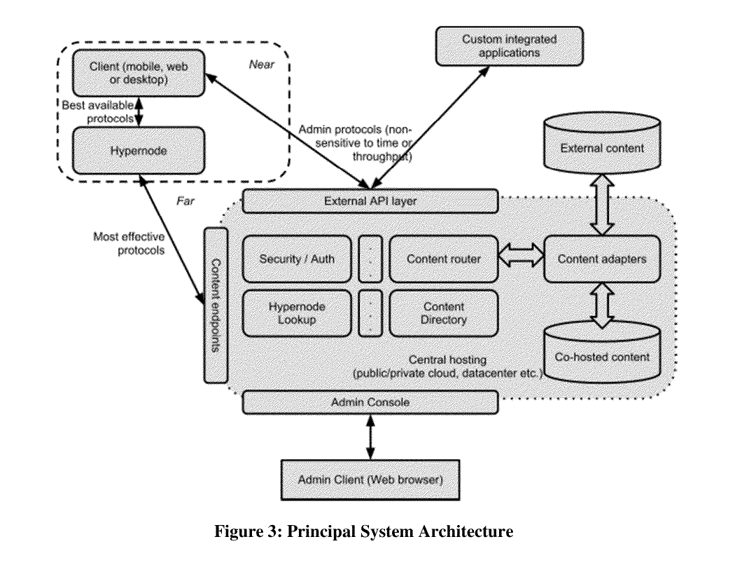

FIG. 3 shows the architecture of the system according to one embodiment.

Hypernode

A hypernode is a special type of component designed to resolve the combination of network limitations and problems that commonly occur when working with clients that are located between uncontrolled firewalls or routers. For example, most home networks do not have a real IP and are located behind routers that block certain kind of incoming traffic. Most mobile devices can hardly use the UDP transport protocols on their operator networks and can only rely on TCP. However, incoming traffic should be open to allow effective content exchange, and TCP is not entirely suitable for real time media content delivery such as VoIP calls, unless the peers are closely located (both geographically and in terms of network topology).

Accordingly, in some embodiments, a hypernode in the system allows the use of the best available protocol for each client to allow the information to flow. If the system is arranged such that there is always a hypernode that is closely located to the client, the negative effects of those protocols (such as being open only in one direction or having high latency etc.) can be circumvented, reduced or minimized.

In some embodiments, for example, if the client is a 4G mobile device on a network that does not allow UDP traffic or has high packet loss, the hypernode that is located close to the Client opens a TCP connection to the client instead. However, the connection between the hypernode and the Content Endpoints in the Central Hosting is fast and permissive, so the hypernode uses only TCP between the Client and itself; and between the hypernode and the Content Endpoints a highly efficient UDP connection is open.

In addition to switching protocols, hypernodes are capable of transcoding content if necessary for matching client capabilities on one side and requirements of the Central Hosting on the other.

Conceptually, the hypernode compensates for the limitations of client's network connectivity and content consumption/generation capabilities by being fast and close to the client's location on the network.

Of course, this assumes that hypernodes are suitably located to accommodate different client locations. Allocating Hypernodes in various Internet key points and geographical areas is an important technical step of the deployment process in some embodiments.

Admin Console

The Admin Console provides the some or all of the following functionality to the System Administrators in some embodiments:
Access control
Content management
Analytics
Reports
Audit logging
Configuration

The Admin Console is a Web Application that can be used from any web browser according to some embodiments.

External API Integration

The externally available functions of the system may be exposed as an open API that can be used by publishers to integrate their existing applications with the system or create new use cases for the system by designing completely new applications.

The API is exhibited as a combination of HTTP and XMPP endpoints, each running over a secure TLS layer.

The API may provide some or all of the below functionality in some embodiments:
Content management;
Hypernode lookup;
Coordination (accessing content streams);
Session management; and
Configuration management

The client components of the system use the same external API that is exposed for third-party integrations.

Content Endpoints

According to some embodiments, the content streams are exposed to hypernodes as separate UDP or TCP endpoints. This arrangement permits the use of effective content streaming protocols such as RTP. Thus, coordination is used for clients to request access to content streams that eventually push content to hypernodes which, in turn, deliver the content to clients.

In some embodiments, the system uses its own protocols for coordination, lookup and directory services for the content it servers because the industry does not have a single protocol that would provide those services to the appropriate level. In some embodiments, multiple industry protocols may be combined, though scalability can be a challenge in such embodiments.

A content delivery system in accordance with the techniques described herein may take any suitable form, as aspects of the present invention are not limited in this respect. An illustrative implementation of a computer system 400 that may be used in connection with some embodiments of the present invention is shown in FIG. 4. One or more computer systems such as computer system 400 may be used to implement any of the functionality described above. The computer system 400 may include one or more processors 410 and one or more computer-readable storage media (i.e., tangible, non-transitory computer-readable media), e.g., volatile storage 420 and one or more non-volatile storage media 430, which may be formed of any suitable non-volatile data storage media. The processor 410 may control writing data to and reading data from the volatile storage 420 and/or the non-volatile storage device 430 in any suitable manner, as aspects of the present invention are not limited in this respect. To perform any of the functionality described herein, processor 410 may execute one or more instructions stored in one or more computer-readable storage media (e.g., volatile storage 420), which may serve as tangible, non-transitory computer-readable media storing instructions for execution by the processor 410.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-readable storage medium (i.e., at least one tangible, non-transitory computer-readable medium, e.g., a computer memory, a floppy disk, a compact disk, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of making heterogeneous content available to a client device over a network, the method comprising:
(a) accepting a live content stream and pre-recorded content;
(b) combining the live content stream and the pre-recorded content into a unified stream; and
(c) making the combined content stream available over a network to a client.

2. The method of claim 1, wherein act (c) comprises making the content stream available to a client device at an endpoint.

3. The method of claim 2, wherein act (c) comprises making the content stream available to a client device at a User Datagram Protocol or Transmission Control Protocol endpoint.

4. The method of claim 1, wherein the network comprises the Internet.

5. The method of claim 1, further comprising changing the encoding of the combined content stream based on conditions of the network.

6. A computer system comprising:
a multiplexing module configured to combine a plurality of content streams into a unified content stream;
a transcoder module configured to encode the content within the content stream based on client device requirements and/or network conditions; and
a content endpoint module configured to communicate with a client device over a network.

7. The computer system of claim 6, wherein the content endpoint is configured to communicate with a client device via a hypernode.
